(19) United States
(12) Patent Application Publication
(10) Pub. No.: US 2025/0360722 A1
(43) Pub. Date: Nov. 27, 2025

(54) INK BOTTLE AND INK REPLENISHMENT SYSTEM

(71) Applicant: CANON KABUSHIKI KAISHA, Tokyo (JP)

(72) Inventor: TOSHIO NAKANO, Tokyo (JP)

(21) Appl. No.: 19/212,583

(22) Filed: May 19, 2025

(30) Foreign Application Priority Data
May 21, 2024 (JP) 2024-082515

(51) Int. Cl. B41J 2/175

(52) U.S. Cl. CPC B41J 2/17553

(57) ABSTRACT

The present disclosure suppresses ink leakage while reducing a use amount of a raw material. To this end, the present disclosure is an ink bottle for replenishing an ink tank of a liquid ejection apparatus with an ink, the ink bottle comprising: a main body portion provided with a storage chamber that stores the ink and having a tubular body portion that surrounds at least part of the storage chamber; and a head portion having an opening that allows the storage chamber to communicate with an outside, and a side wall of the body portion is provided with a rib extending between portions near an upper end and a lower end of the side wall, in a direction including a height direction of the side wall as a component. The technique described in the present description can contribute to achieving of a sustainable society such as decarbonized/circulating society.

### BACKGROUND

### Field

The present disclosure relates to an ink bottle and an ink replenishment system.

### Description of the Related Art

Among ink tanks used in an ink ejection apparatus such as an ink jet printer employing a continuous ink supply system (CISS), there is an ink tank on which ink replenishment can be performed. For example, Japanese Patent Laid-Open No. 2020-146991 discloses an ink ejection apparatus in which an ink tank can be replenished with an ink from an ink storage container storing the ink. In order to replenish the ink tank with the ink from the ink storage container in the ink ejection apparatus disclosed in Japanese Patent Laid-Open No. 2020-146991, a user inserts the ink storage container to a joint provided in an upper portion of the ink tank from above the joint while gripping the ink storage container as preparation. Then, the ink replenishment is automatically performed until an entrance of the air discharge passage provided in the joint is blocked by the ink from the ink storage container with which the ink tank is replenished. Accordingly, the user does not have to crush the ink storage container in the ink replenishment of the ink tank from the ink storage container. Meanwhile, in the case where the ink storage container is crushed, the crushing may lead to ink leakage. Accordingly, a side wall of the ink storage container is sometimes designed to be thick to prevent crushing by the user.

In recent years, there is a demand for achieving a sustainable society such as decarbonized/circulating society. To achieve this, it is preferable to reduce a use amount of polypropylene (PP), polyethylene terephthalate (PET), or the like used as a raw material of the ink storage container. Reduction of the thickness of a side wall of the ink storage container can be given as means for reducing the use amount. However, the ink storage container in which the thickness of the side wall is reduced is likely to be crushed and has low impact resistance. Accordingly, there is a concern of occurrence of ink leakage. Particularly, this concern is great in the case where the user inserts the ink storage container to a joint while grabbing the ink storage container.

### SUMMARY

The present disclosure has been made in view of the above-mentioned points, and an object is to suppress ink leakage while reducing a use amount of a raw material.

In a first aspect of the present disclosure, there is provided a An ink bottle for replenishing an ink tank of a liquid ejection apparatus with an ink, the ink bottle comprising: a main body portion provided with a storage chamber and having a tubular body portion that surrounds at least part of the storage chamber, the storage chamber configured to store the ink; and a head portion having an opening that allows the storage chamber to communicate with an outside, wherein a side wall of the body portion is provided with a rib extending between portions near an upper end and a lower end of the side wall, in a direction including a height direction of the side wall as a component.

In a second aspect of the present disclosure, there is provided An ink replenishment system comprising: an ink ejection apparatus including an ink ejection head and an ink tank connected to the ink ejection head, the ink tank configured to store an ink to be supplied to the ink ejection head and being replenishable with the ink from an outside; and the ink bottle configured to store the ink with which the ink tank is to be replenished, wherein the ink bottle including a main body portion provided with a storage chamber and having a tubular body portion that surrounds at least part of the storage chamber, the storage chamber configured to store the ink; and a head portion having an opening that allows the storage chamber to communicate with an outside, wherein a side wall of the body portion is provided with a rib extending between portions near an upper end and a lower end of the side wall, in a direction including a height direction of the side wall as a component, wherein the ink tank includes a joint configured to be inserted into the head portion of the ink bottle through the opening, and wherein the joint is provided with an ink inlet passage through which the ink flows from the storage chamber into the ink tank and an air discharge passage through which air inside the ink tank is discharged to the storage chamber.

Further features of the present disclosure will become apparent from the following description of exemplary embodiments with reference to the attached drawings.

### BRIEF DESCRIPTION OF THE DRAWINGS

FIG. 1 is a schematic perspective diagram of an ink ejection apparatus;

FIG. 2 is a side view with a cross section illustrating a sketch of a sealing cap-equipped ink storage container according to a first embodiment;

FIGS. 3A and 3B are a side diagram and a perspective diagram illustrating the sealing cap-equipped ink storage container according to the first embodiment;

FIGS. 4A to 4C are a cross-sectional diagram, a perspective diagram, and a partial cross-sectional diagram of a body portion of an ink storage container according to the first embodiment;

FIGS. 5A to 5C are conceptual diagrams illustrating a procedure in which a user prepares to replenish an ink tank with an ink from the ink storage container;

FIGS. 6A to 6C are diagrams illustrating a principle of replenishing the ink tank with the ink from the ink storage container;

FIGS. 7A and 7B are a diagram illustrating deformation caused by grip force of the user in an ink storage container in which no ribs are provided in a body portion and a diagram illustrating deformation caused by the grip force of the user in the ink storage container in which ribs are provided in the body portion;

FIGS. 8A and 8B are a cross-sectional diagram and a perspective diagram of the body portion of the ink storage container according to a second embodiment;

FIGS. 9A to 9C are two cross-sectional diagrams of the body portion of the ink storage container according to a third embodiment and a cross-sectional diagram of a neck portion of the ink storage container;

FIGS. 10A and 10B are a cross-sectional diagram and a perspective diagram of the body portion of the ink storage container according to a fourth embodiment;

FIGS. 11A to 11D are a cross-sectional diagram, a perspective diagram, a partial cross-sectional diagram, and a cross-sectional diagram of the body portion of the ink storage container according to a fifth embodiment;

FIGS. 12A to 12C are a cross-sectional diagram, a perspective diagram, and a cross-sectional diagram of the body portion of the ink storage container according to a sixth embodiment;

FIGS. 13A and 13B are a cross-sectional diagram and a perspective diagram of the body portion of the ink storage container in which the ink remains;

FIGS. 14A and 14B are a cross-sectional diagram and a perspective diagram of the body portion of the ink storage container in which the ink remains;

FIGS. 15A to 15C are a cross-sectional diagram and two perspective diagrams of the body portion of the ink storage container according to a seventh embodiment;

FIGS. 16A and 16B are a side diagram and a perspective diagram illustrating the sealing cap-equipped ink storage container according to an eighth embodiment;

FIGS. 17A to 17C are a side diagram, a perspective diagram, and a neck portion cross-sectional diagram illustrating the sealing cap-equipped ink storage container according to a ninth embodiment;

FIGS. 18A and 18B are side diagrams illustrating the main body portion in which ribs according to the ninth embodiment are arranged; and

FIGS. 19A to 19C are a side diagram, a perspective diagram, and a neck portion cross-sectional diagram illustrating a small sealing cap-equipped ink storage container.

### DESCRIPTION OF THE EMBODIMENTS

Embodiments are explained below in detail with reference to the attached drawings. Note that the following embodiments do not limit the disclosure according to the scope of claims. Although multiple characteristics are described in the embodiments, not all of the multiple characteristics are necessarily essential for the disclosure, and the multiple characteristics may be used in any combination. Moreover, the same or similar configurations are denoted by the same reference numerals in the attached drawings, and overlapping explanation is omitted in some cases.

### First Embodiment

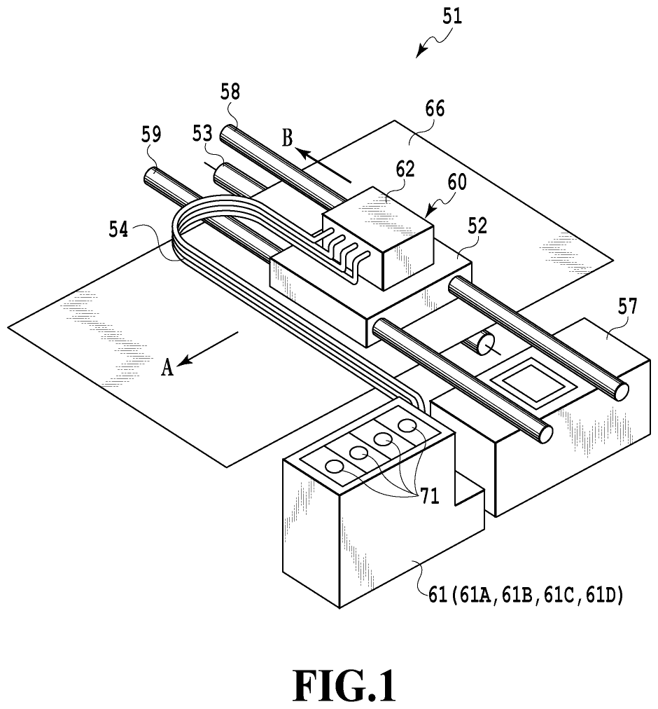

Explanation is given of an ink ejection apparatus that is replenished with inks from ink storage containers of the present disclosure. FIG. 1 is a schematic perspective diagram of an ink ejection apparatus 51 according to a first embodiment of the present disclosure. The ink ejection apparatus 51 includes a carriage 52, a conveyance roller 53, tubes 54, a cap unit 57, a first shaft 58, a second shaft 59, an ink ejection head 60, ink tanks 61, and sub tanks 62. The ink ejection head 60 and the sub tanks 62 are provided in the carriage 52. The ink tanks 61 are tanks that store the inks, and are provided in a main body portion of the ink ejection apparatus 51. A print medium 66 is conveyed in a conveyance direction A of the print medium 66 by the conveyance roller 53. In synchronization with this conveyance, the ink ejection head 60 supported on the carriage 52 performs printing on the print medium 66 while reciprocally moving along the first shaft 58 and the second shaft 59. The ink ejection head 60 is connected to the ink tanks 61 by the tubes 54 via the sub tanks 62, and the inks are supplied from the ink tanks 61 to the ink ejection head 60. The ink tanks 61 include ink tanks 61A, 61B, 61C, and 61D for four colors of black, cyan, magenta, and yellow. Each of the ink tanks 61A, 61B, 61C, and 61D is provided with an atmosphere opening unit 71. Note that the number of colors of the ink tanks 61 is not limited to four, and may be any number.

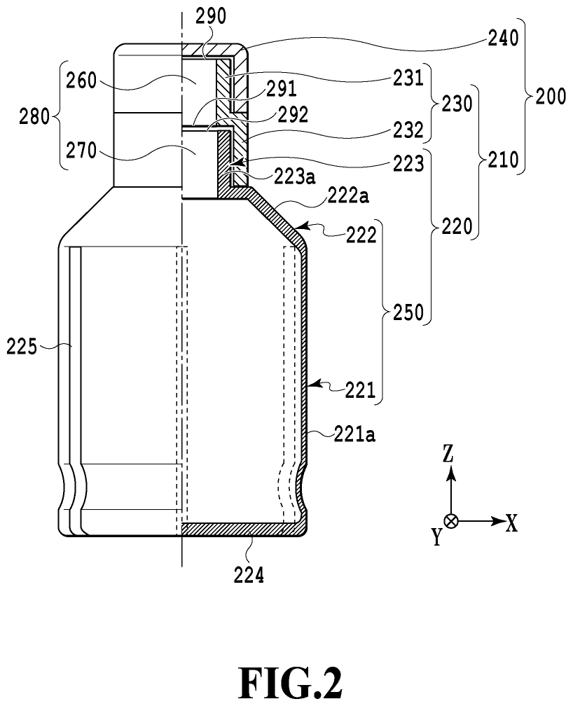

FIG. 2 illustrates a side view with a cross section illustrating a sketch of a sealing cap-equipped ink storage container. The sealing cap-equipped ink storage container 200 illustrated in FIG. 2 is an ink bottle including an ink storage container 210 and a sealing cap 240. The ink storage container 210 is sealed with the sealing cap 240 in the case where the ink storage container 210 is stored or transported in a distribution channel. Each ink tank 61 can be replenished with the ink from the ink storage container 210. In the replenishment of the ink tank 61 with the ink from the ink storage container 210, the sealing cap 240 is removed from the ink storage container 210. The ink ejection apparatus 51 and the ink storage container 210 (or the sealing cap-equipped ink storage container 200) form an ink replenishment system.

Although the ink storage container 210 has a two-part configuration including a main body portion 220 and a head portion 230, these parts may be integrated.

The main body portion 220 includes a body portion 221, a shoulder portion 222, and a neck portion 223. The body portion 221 and the shoulder portion 222 form a storage chamber 250 for storing the ink. The outer shape of the body portion 221 is a cylindrical shape, the outer shape of the shoulder portion 222 is a truncated cone shape, and the outer shape of the neck portion 223 is a cylindrical shape. A disc-shaped bottom portion 224 is provided at a lower end of the body portion 221. A side wall 221a of the body portion 221 and a side wall 222a of the shoulder portion 222 are joined to each other on one end portion side of the shoulder portion 222. The side wall 222a of the shoulder portion 222 and a side wall 223a of the neck portion 223 are joined to each other at the other end portion side of the shoulder portion 222. An inside of the body portion 221, an inside of the shoulder portion 222, and an inside of the neck portion 223 communicate with one another, and a third opening 292 is opened at an upper end of the neck portion 223. The lower end of the body portion 221 is closed by the bottom portion 224.

Although a constricted part is provided near the lower end of the body portion 221 illustrated in FIG. 2, the ink storage container 210 is not limited to this, the constricted part may not be provided.

The head portion 230 includes a first head portion 231 and a second head portion 232. For example, the sealing cap 240 is detachably attached to the first head portion 231 in a screw method. The second head portion 232 is fitted to the neck portion 223. The second head portion 232 and the neck portion 223 may be joined to each other in the screw method, welded to each other, or bonded to each other. Moreover, the head portion 230 may be integrated with the main body portion 220 from the beginning.

The ink is stored in the storage chamber 250, and the storage chamber 250 is normally filled with the ink up to an intermediate height position of the shoulder portion 222. The diameter of the body portion 221 is about 60 to 80 mm.

A first flow passage 260 is formed inside the first head portion 231, and a second flow passage 270 is formed inside the neck portion 223. A first opening 290 is opened in an upper end portion of the first flow passage 260, and a second opening 291 is opened in a lower end portion of the first flow passage 260. A flow passage 280 is formed by combining the first flow passage 260 and the second flow passage 270. It is possible to make the ink flow into the storage chamber 250 from the outside or make the ink stored in the storage chamber 250 to flow to the outside (ink tank 61 or the like) via the flow passage 280 in a state where the sealing cap 240 is removed from the ink storage container 210. Specifically, the head portion 230 is a guide portion for causing the ink stored in the main body portion 220 to flow to the outside.

As illustrated in FIG. 2, the thickness of the side wall 221a of the body portion 221 is configured to be smaller than the thickness of the bottom portion 224, the thickness of the side wall 222a of the shoulder portion 222, and the thickness of the side wall 223a of the neck portion 223. The surface area of the side wall 221a of the body portion 221 accounts for most of the surface area of the main body portion 220. Accordingly, a use amount of a raw material necessary for forming the main body portion 220 can be reduced. For example, polypropylene (PP) or polyethylene terephthalate (PET) is used as the raw material of the main body portion 220.

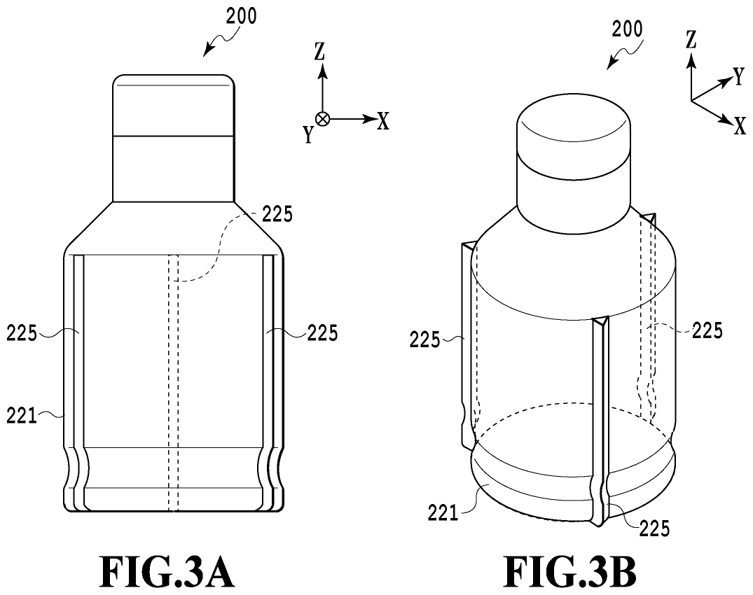

FIGS. 3A and 3B are a side diagram and a perspective diagram illustrating the sealing cap-equipped ink storage container 200.

As illustrated in FIGS. 2, 3A, and 3B, three ribs 225 are provided on the side wall 221a of the body portion 221. Each rib 225 extends in a height direction (Z direction) of the body portion 221. Providing the three ribs 225 on the side wall 221a of the body portion 221 can make up for a decrease of strength of the body portion 221 caused by reduction of the thickness of the side wall 221a.

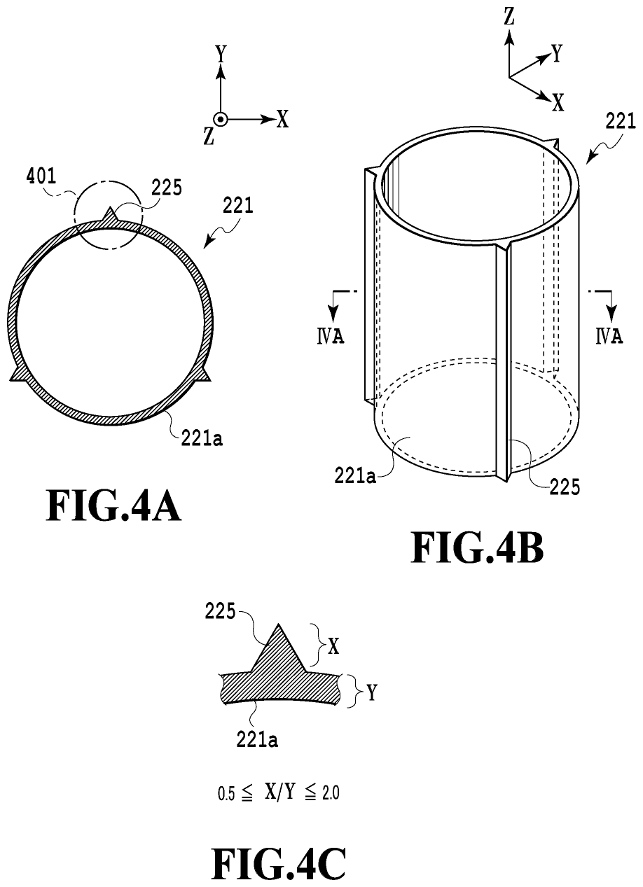

FIGS. 4A to 4C illustrate a cross-sectional diagram, a perspective diagram, and a partial cross-sectional diagram of the body portion 221 of the ink storage container 210. As illustrated in FIGS. 4A to 4C, the cross-sectional shape of the ribs 225 is a triangle. However, the cross-sectional shape is not limited to this, and may be, for example, a quadrilateral, a true semi-circle, a semi-ellipsoid, or the like.

As illustrated in FIG. 4B, the ribs 225 preferably extend across a range from an upper end to a lower end of the side wall 221a of the body portion 221. However, the ribs 225 are not limited to this, and may extend without extending to portions near the upper end and the lower end. Specifically, the ribs 225 do not have to be provided in the portions near the upper end and the lower end of the side wall 221a.

As illustrated in FIG. 4C, the following relationship is preferably satisfied for a ratio X/Y, where X is the thickness of the ribs 225, and Y is the thickness of the side wall 221a of the body portion 221:

0.5≤X/Y≤2.0.

An inner surface that is the opposite surface to an outer surface having protruding portions forming the ribs 225 does not have recess portions corresponding to the protruding portions forming the ribs 225. In other words, the inner surface that is the opposite surface to the outer surface having the protruding portions forming the ribs 225 is a smooth surface.

For example, the ribs 225 can be provided on the side wall 221a as illustrated in FIGS. 4A to 4C in the case where the ink storage container 210 is molded by an injection molding method.

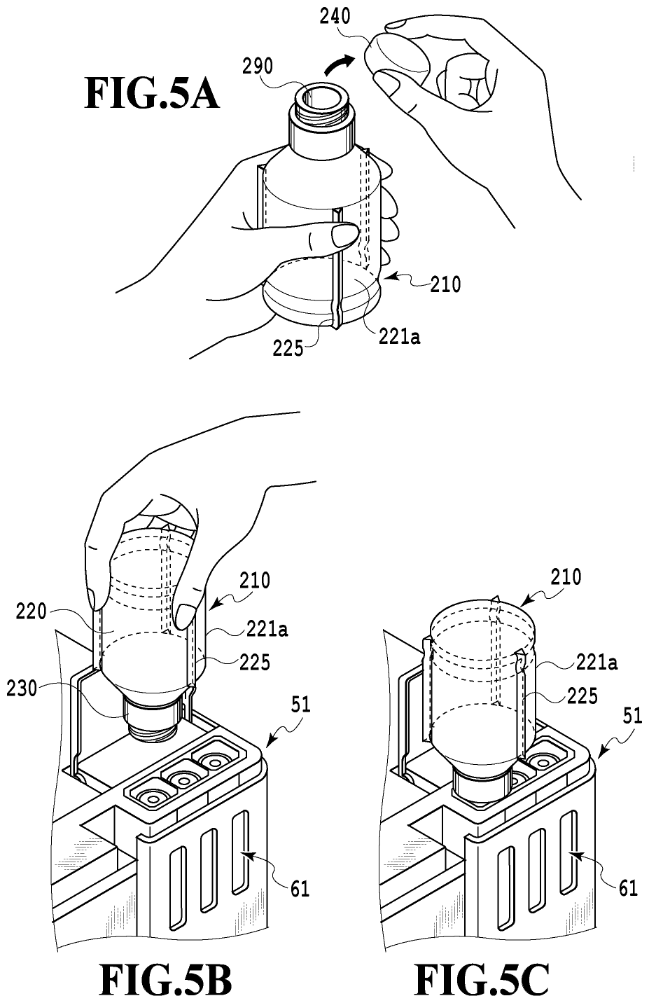

FIGS. 5A to 5C are conceptual diagrams illustrating a procedure in which a user prepares to replenish the ink tank 61 with the ink from the ink storage container 210.

As illustrated in FIG. 5A, the user grabs the ink storage container 210 with one hand, and removes the sealing cap 240 from the ink storage container 210. In this case, grip force of the user is applied to the side wall 221a of the body portion 221 of the ink storage container 210 as external force. However, as described above, the side wall 221a is reinforced by the ribs 225. Accordingly, it is possible to avoid the case where the side wall 221a is crushed and the ink thereby leaks out from the first opening 290 of the ink storage container 210.

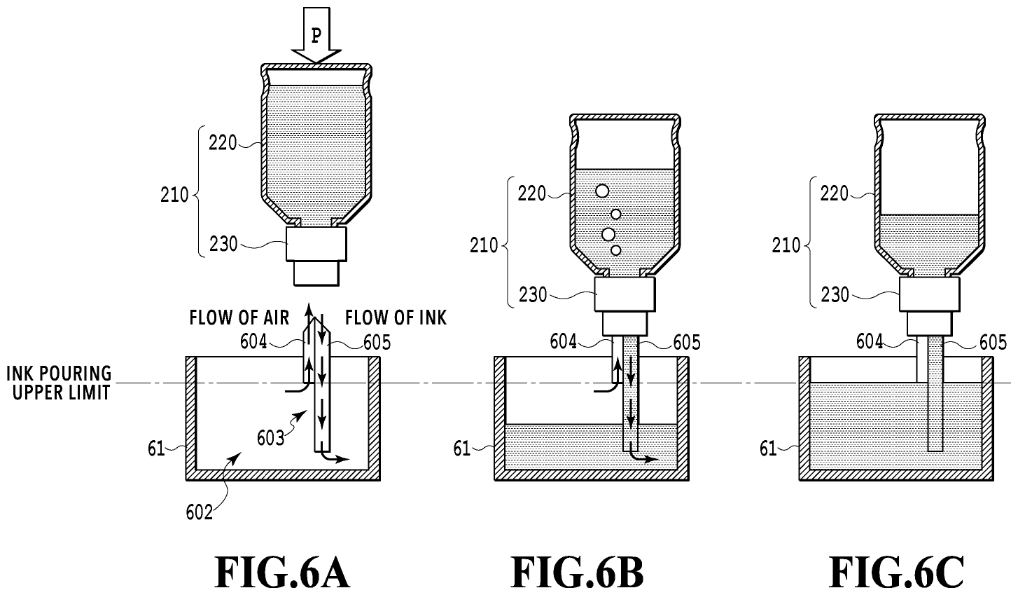

As illustrated in FIG. 5B, next, the user turns the ink storage container 210 upside down while gripping the ink storage container 210. Specifically, the user sets the ink storage container 210 to such a posture that the head portion 230 is located below the main body portion 220 in the vertical direction. Then, the user lowers the ink storage container 210 such that a joint 603 (see FIG. 6) provided above the ink tank 61 is inserted into the flow passage 280. Also in this case, the grip force of the user is applied to the side wall 221a of the body portion 221 of the ink storage container 210 as external force. Particularly, as illustrated in FIG. 5B, for example, the fingertips of the user are put on a portion of the side wall 221a that is closer to the bottom portion 224 than the center of the side wall 221a in the height direction, and most of the force is applied to this portion. However, since the side wall 221a is reinforced by the ribs 225 as described above, crushing of the side wall 221a can be avoided. Thus, excessive flow out of the ink from the first opening 290 of the ink storage container 210 can be avoided. Particularly, in a state as illustrated in FIG. 5B, the ink excessively flowing out does not necessarily flow into the ink tank 61, and there is a possibility that the ink enters the main body of the ink ejection apparatus 51. However, since the side wall 221a is reinforced by the ribs 225, this situation can be avoided.

The ink refilling from the ink storage container 210 to the ink tank 61 is continued in a state where the ink storage container 210 is arranged as illustrated in FIG. 5C, until the ink refilling is automatically completed.

FIGS. 6A to 6C are diagrams illustrating a principle of replenishing the ink tank 61 with the ink from the ink storage container 210.

An ink chamber 602 of the ink tank 61 can be replenished with the ink stored in the ink storage container 210. The joint 603 configured to be inserted into the head portion 230 of the ink storage container 210 through the first opening 290 is provided on an upper surface of the ink chamber 602. The joint 603 is provided with an air discharge passage 604 and an ink inlet passage 605 corresponding to a gas-liquid separation method. As illustrated in FIG. 6A, the ink storage container 210 in such a posture that the head portion 230 is located below the main body portion 220 in the vertical direction is moved downward as illustrated by the arrow P, and the joint 603 is thereby inserted into the head portion 230. Then, as illustrated in FIG. 6B, the ink flows from the ink storage container 210 into the ink chamber 602 of the ink tank 61 via the ink inlet passage 605, and air inside the ink chamber 602 of the ink tank 61 is discharged to the ink storage container 210 via the air discharge passage 604. Then, as illustrated in FIG. 6C, in the case where the water head of the ink reaches an entrance at a lower end of the air discharge passage 604 in the ink chamber 602 of the ink tank 61, the flow of air stops and the flow of ink also stops with this. Specifically, the automatic replenishment of the ink automatically stops. Note that, in FIG. 6A, the arrows illustrated in the air discharge passage 604 and the ink inlet passage 605 are for explanation.

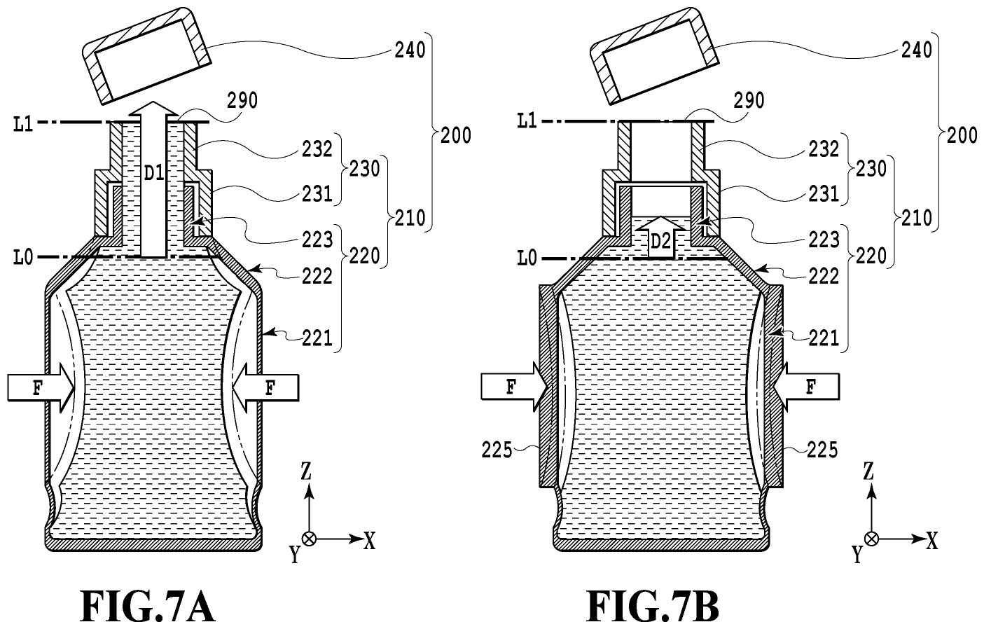

FIGS. 7A and 7B are a diagram illustrating deformation caused by the grip force of the user in an ink storage container in which no ribs 225 are provided in the body portion 221 and a diagram illustrating deformation caused by the grip force of the user in the ink storage container in which the ribs are provided in the body portion. Note that FIGS. 7A and 7B are diagrams obtained by combining a half cross-sectional diagram at a circumferential angle of 0 degrees and a half cross-sectional diagram at a circumferential angle of 120 degrees or 240 degrees in a case where three ribs 225 are arranged at equal intervals of 120 degrees in a circumferential direction of the body portion 221.

As illustrated in FIG. 7A, in the configuration in which no ribs 225 are provided on the side wall 221a of the body portion 221, there is a possibility of the ink leaking out from the ink storage container 210. This is explained with reference to FIG. 7A. In the configuration in which no ribs 225 are provided on the side wall 221a of the body portion 221, in the case where the water head of the ink is at the height of L0 and external force F such as the grip force of the user is applied to the side wall 221a, the side wall 221a and side walls around the side wall 221a are deformed as illustrated by the dash-dot-dot lines. As illustrated by the arrow D1, there is a possibility that this deformation causes the water head of the ink to exceed the height L1 of the first opening 290 and causes the ink to leak out from the ink storage container 210.

Meanwhile, in the configuration in which the ribs 225 are provided on the side wall 221a of the body portion 221, the leak-out of the ink from the ink storage container 210 can be avoided. This is explained with reference to FIG. 7B. In the configuration in which the ribs 225 are provided on the side wall 221a of the body portion 221, in the case where the water head of the ink is at the height of L0 and external force F such as the grip force of the user is applied to the side wall 221a, the side wall 221a and the side walls around the side wall 221a are deformed as illustrated by dash-dot-dot lines in FIG. 7B. A deformation amount illustrated in FIG. 7B is smaller than a deformation amount illustrated in FIG. 7A. This causes the water head of the ink not to exceed the height L1 of the first opening 290 as illustrated by the arrow D2, and the leak-out of the ink from the ink storage container 210 can be thus avoided.

### Second Embodiment

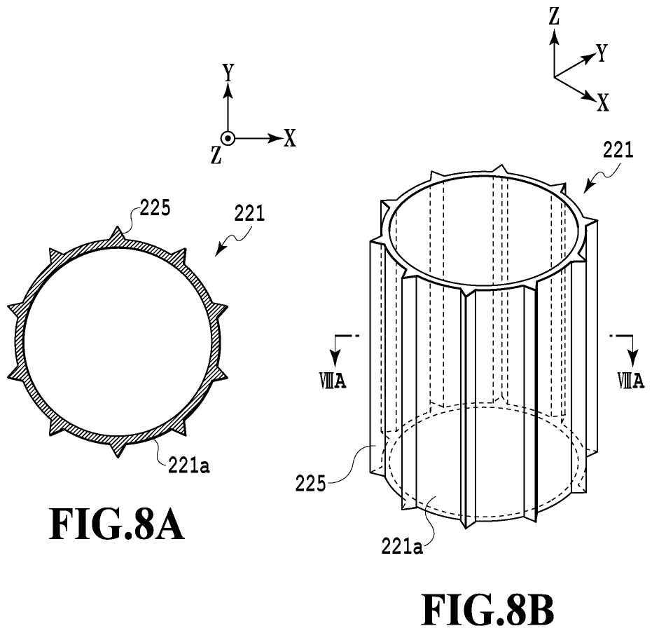

FIGS. 8A and 8B are a cross-sectional diagram and a perspective diagram of the body portion 221 of the ink storage container 210.

In a second embodiment, the number of ribs 225 is ten. This can reduce deformation of the body portion 221 and the like caused by the external force from that in the first embodiment in which the number of ribs 225 is three.

Note that, basically, it is only necessary that three or more ribs 225 are provided on the side wall 221a of the body portion 221. The number of ribs 225 may be ten as in the second embodiment or another number as necessary. For example, the number of ribs 225 may be determined by increasing the ribs 225 one by one while experimentally checking the strength in a design stage. Note that a distance between the ribs 225 along the side wall 221a is preferably 30 mm or less.

### Third Embodiment

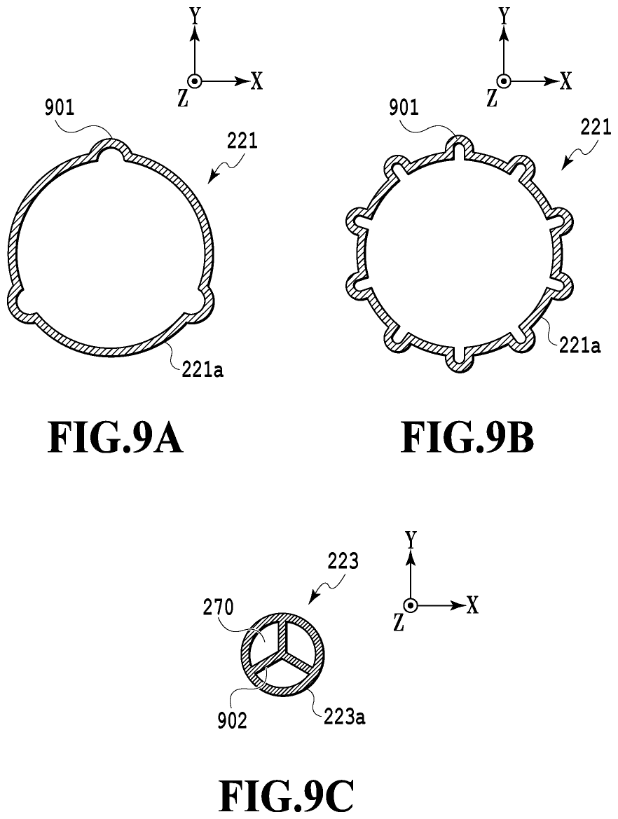

FIGS. 9A to 9C are two cross-sectional diagrams of the body portion 221 of the ink storage container 210 according to a third embodiment and a cross-sectional diagram of the neck portion 223 of the ink storage container 210.

As illustrated in FIG. 9A, ribs 901 are formed as if by deforming the side wall 221a of the body portion 221. In this configuration, the inner surface that is the opposite surface to the outer surface having the protruding portions forming the ribs 901 has recess portions corresponding to the protruding portions forming the ribs 901. The thickness of the side wall 221a in portions where the ribs 901 are provided is substantially the same as the thickness of the side wall 221a in portions where no ribs 901 are provided.

For example, in the case where the ink storage container 210 is molded by a blow molding method, the ribs 901 can be provided on the side wall 221a as illustrated in FIG. 9A.

The configuration illustrated in FIG. 9B is basically the same as the configuration illustrated in FIG. 9A, but is different from the configuration illustrated in FIG. 9A in that the number of ribs 901 is changed from three to ten. This can reduce deformation of the body portion 221 and the like caused by the external force from that in the configuration of FIG. 9A in which the number of ribs 901 is three.

FIG. 9C illustrates a configuration in which three ribs 902 linking an inner surface of the side wall 223a of the neck portion 223 are provided in the second flow passage 270. This configuration can be applied also to the first embodiment and the second embodiment. Particularly, in the case where the side wall 223a of the neck portion 223 is made thinner as described later, the ribs 902 can reinforce the neck portion 223.

### Fourth Embodiment

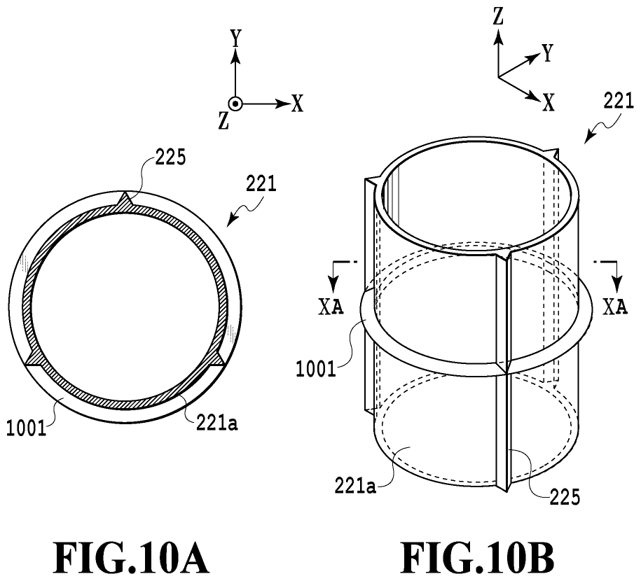

FIGS. 10A and 10B are a cross-sectional diagram and a perspective diagram of the body portion 221 of the ink storage container 210 according to a fourth embodiment.

The body portion 221 of the ink storage container 210 according to the fourth embodiment is different from the body portion 221 of the ink storage container 210 according to the first embodiment in that a rib 1001 is added.

The rib 1001 is an annular rib that extends in the circumferential direction of the body portion 221 near the center of the body portion 221 in the height direction (Z direction) thereof.

Note that, although only one rib 1001 is illustrated in FIGS. 10A and 10B, multiple ribs 1001 may be provided. Specifically, in the present embodiment, it is only necessary that one or more ribs 1001 are provided on the side wall 221a of the body portion 221. Moreover, in the case where two or more ribs 1001 are provided, the two or more ribs 1001 may be equally arranged in the height direction of the body portion 221 or unevenly arranged in consideration of a characteristic of deformation against force.

The rib 1001 may be arranged at a position, in the height direction, corresponding to a position where the user puts his/her palm or fingers. For example, according to the fact that the user grabs a portion near the center of the body portion 221 in the height direction thereof as illustrated in FIG. 5A, the rib 1001 may be provided at a position near this portion in the height direction. According to the fact that the user grabs a portion closer to the bottom portion 224 than the center of the body portion 221 in the height direction thereof as illustrated in FIG. 5B, the rib 1001 may be provided at a position near this portion in the height direction.

Although the cross-sectional shape of the rib 1001 illustrated in FIGS. 10A and 10B is a triangle, the cross-sectional shape is not limited to this, and may be a quadrilateral, a true semi-circle, a semi-ellipsoid, or the like.

Providing the rib 1001 can increase the strength of a portion far from the ribs 225. Moreover, strength of a portion highly likely to be grabbed by the user can be increased.

### Fifth Embodiment

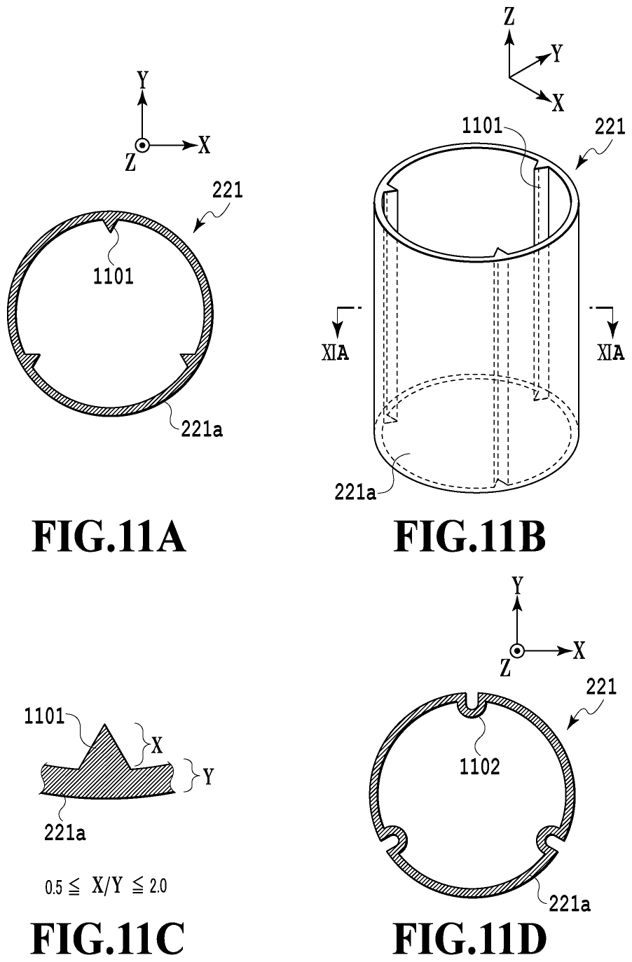

FIGS. 11A to 11D are a cross-sectional diagram, a perspective diagram, a partial cross-sectional diagram, and another cross-sectional diagram of the body portion 221 of the ink storage container 210 according to the fifth embodiment.

The body portion 221 of the ink storage container 210 according to the fifth embodiment is different from the body portion 221 of the ink storage container 210 according to the first embodiment in that ribs 1101 are provided instead of the ribs 225.

The ribs 225 according to the first embodiment are provided on the outer surface of the side wall 221a of the body portion 221, while the ribs 1101 according to the fifth embodiment are provided on the inner surface of the side wall 221a of the body portion 221.

As illustrated in FIGS. 11A to 11C, the cross-sectional shape of the ribs 1101 is a triangle. However, the cross-sectional shape is not limited this, and may be, for example, a quadrilateral, a true semi-circle, a semi-ellipsoid, or the like.

As illustrated in FIG. 11B, the ribs 1101 preferably extend across a range from the upper end to the lower end of the side wall 221a of the body portion 221. However, the ribs 1101 are not limited to this, and may extend without extending to portions near the upper end and the lower end. Specifically, the ribs 1101 do not have to be provided in the portions near the upper end and the lower end of the side wall 221a.

As illustrated in FIG. 11C, the following relationship is preferably satisfied for a ratio X/Y, where X is the thickness of the ribs 1101, and Y is the thickness of the side wall 221a of the body portion 221:

0.5≤X/Y≤2.0.

The rib 1001 illustrated in FIGS. 10A and 10B may be added to the configuration of FIGS. 11A to 11D. In this case, the ribs 1101 are provided on the inner surface of the side wall 221a, but the rib 1001 is provided on the outer surface of the side wall 221a.

The outer surface that is the opposite surface to the inner surface having protruding portions forming the ribs 1101 does not have recess portions corresponding to the protruding portions forming the ribs 1101.

For example, in the case where the ink storage container 210 is molded by an injection molding method, the ribs 1101 can be provided on the side wall 221a as illustrated in FIGS. 11A to 11C.

As illustrated in FIG. 11D, ribs 1102 are formed as if by deforming the side wall 221a of the body portion 221. In this configuration, the inner surface that is the opposite surface to the outer surface having protruding portions forming the ribs 1102 has recess portions corresponding to the protruding portions forming the ribs 1102.

For example, in the case where the ink storage container 210 is molded by a blow molding method, the ribs 1102 can be provided on the side wall 221a as illustrated in FIG. 11D.

According to the configuration of the present embodiment, no ribs 1101 are provided on the outer surface of the side wall 221a of the body portion 221 of the ink storage container 210. Accordingly, the flatness of the outer surface of the side wall 221a of the body portion 221 is maintained, and a label can be easily attached to the outer surface in a production stage or the like.

### Sixth Embodiment

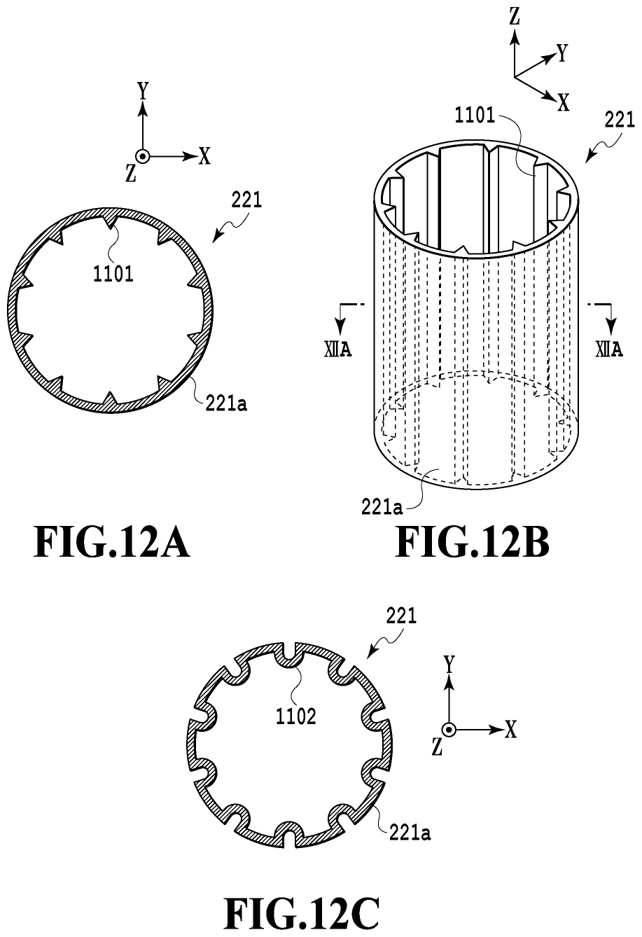

FIGS. 12A to 12C are a cross-sectional diagram, a perspective diagram, and another cross-sectional diagram of the body portion 221 of the ink storage container 210 according to a sixth embodiment.

The body portion 221 of the ink storage container 210 illustrated in FIGS. 12A and 12B according to the sixth embodiment is different from the body portion 221 of the ink storage container 210 illustrated in FIGS. 11A and 11B according to the fifth embodiment in that the number of ribs 1101 is increased to ten.

This can reduce deformation of the body portion 221 and the like caused by the external force from that in the fifth embodiment in which the number of ribs 1101 is three.

Note that, basically, the number of ribs 1101 only needs to be three or more, and may be ten as in the sixth embodiment or another number as necessary.

Similarly, the body portion 221 of the ink storage container 210 illustrated in FIG. 12C according to the sixth embodiment is different from the body portion 221 of the ink storage container 210 illustrated in FIG. 11D according to the fifth embodiment in that the number of ribs 1102 is increased from three to ten.

This can reduce deformation of the body portion 221 and the like caused by the external force from that in the fifth embodiment in which the number of ribs 1102 is three.

Note that, basically, the number of ribs 1102 only needs to be three or more, and may be ten as in the sixth embodiment or another number as necessary.

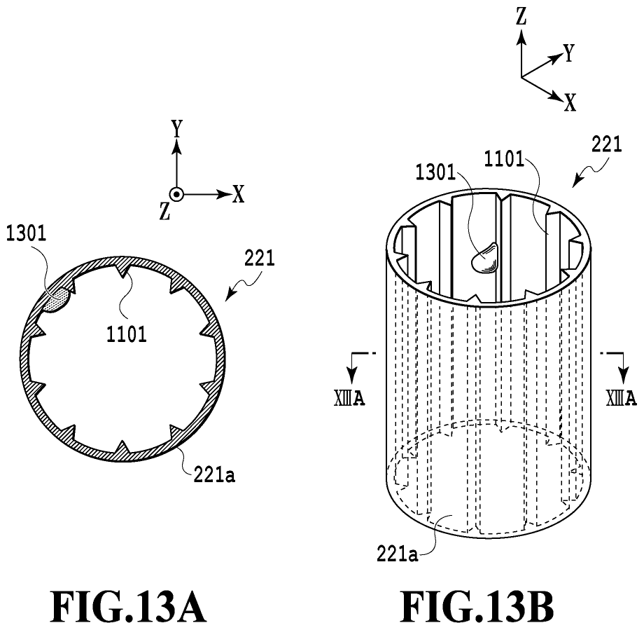

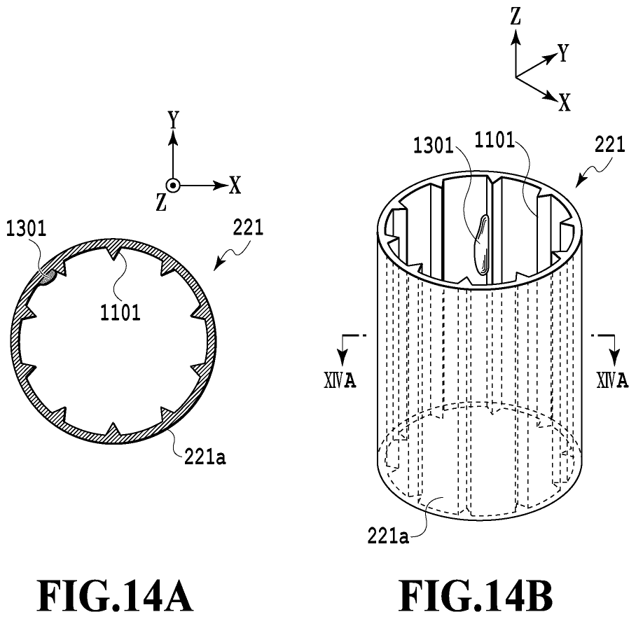

FIGS. 13A and 13B illustrate a cross-sectional diagram and a perspective diagram of the body portion 221 of the ink storage container 210 in which the ink remains, and FIGS. 14A and 14B also illustrate a cross-sectional diagram and a perspective diagram of the body portion 221 of the ink storage container 210 in which the ink remains.

A droplet 1301 of the ink attached to the inner surface of the body portion 221 is illustrated in FIGS. 13A and 13B. The droplet 1301 of the ink attached to the inner surface of the body portion 221 is illustrated also in FIGS. 14A and 14B.

In the case where the droplet 1301 initially has a shape as illustrated in FIGS. 13A and 13B, the shape of the droplet 1301 changes to a shape as illustrated in FIGS. 14A and 14B after elapse of a predetermined time. The droplet 1301 illustrated in FIGS. 14A and 14B has a larger contact area with the rib 1101 than the droplet 1301 illustrated in FIGS. 13A and 13B, and is greatly attracted to the rib 1101. As described above, each rib 1101 has an effect of attracting the droplet 1301. The droplet 1301 attracted to the rib 1101 then drops downward in the vertical direction along the rib 1101. Accordingly, the ink remaining in the ink storage container 210 after completion of ink refilling can be reduced.

Moreover, providing the ribs 1101 can promote upward movement of air bubbles that have entered the ink storage container 210 via the air discharge passage 604 in a period in which the ink tank 61 is refilled with the ink. Accordingly, the drop speed of the entire ink can be increased. Thus, time required to replenish the ink tank 61 with the ink can be reduced.

As described above, in the case where the ink storage container 210 is in the posture as illustrated in FIGS. 5C and 6B, the ink tank 61 is replenished with the ink stored in the ink storage container 210. Since the ribs 1101 are provided on the inner surface of the body portion 221, the remaining ink droplets drop downward in the vertical direction along the ribs 1101 as explained with reference to FIGS. 13A, 13B, 14A, and 14B. Accordingly, the ink remaining inside the ink storage container 210 after the completion of ink replenishment can be reduced. In this case, in a configuration without the ribs 1101, the maximum width of the ink droplet 1301 remaining on the inner surface of the side wall 221a of the body portion 221 is about 10 mm according to measurement. Assume that the width of the ink droplet 1301 is evenly distributed in a range of 0 mm to 10 mm. In this case, setting the intervals of the ribs 1101 to 5 mm can make half of all droplets to drop, the droplets being droplets that would otherwise remain on the inner surface of the side wall 221a of the body portion 221 in the case where there are no ribs 1101. Assuming that distribution of the width of the ink droplet 1301 is shifted toward the larger side, half or more of the droplets 1301 can be made to drop. Moreover, since there is a process in which a large droplet attracted toward the rib 1101 absorbs other small droplets around the large droplet, more droplets 1301 can be made to drop. Furthermore, in the case where the intervals of the ribs (that is, a distance between two adjacent ribs 1101 along the circumferential direction of the side wall 221a of the body portion 221) is set to 5 mm or less, more droplets 1301 can be made to drop. Accordingly, 5 mm that is half the length of the maximum width 10 mm of the droplet that would otherwise remain without the ribs 1101 can be defined as the maximum possible value of the intervals of the ribs 1101. In the case where the maximum width of the droplet that would otherwise remain without the ribs 1101 is another value, the maximum possible value of the intervals of the ribs 1101 also has another value depending on the maximum width.

Note that setting the vertex angle of the ribs 1101 whose cross-sectional shape is a triangle to an acute angle can improve the effect of attracting the ink to the ribs 1101. Moreover, bubbles remaining after the completion of ink refilling may be removed by being attracted to the ribs 1101 like the remaining droplets.

### Seventh Embodiment

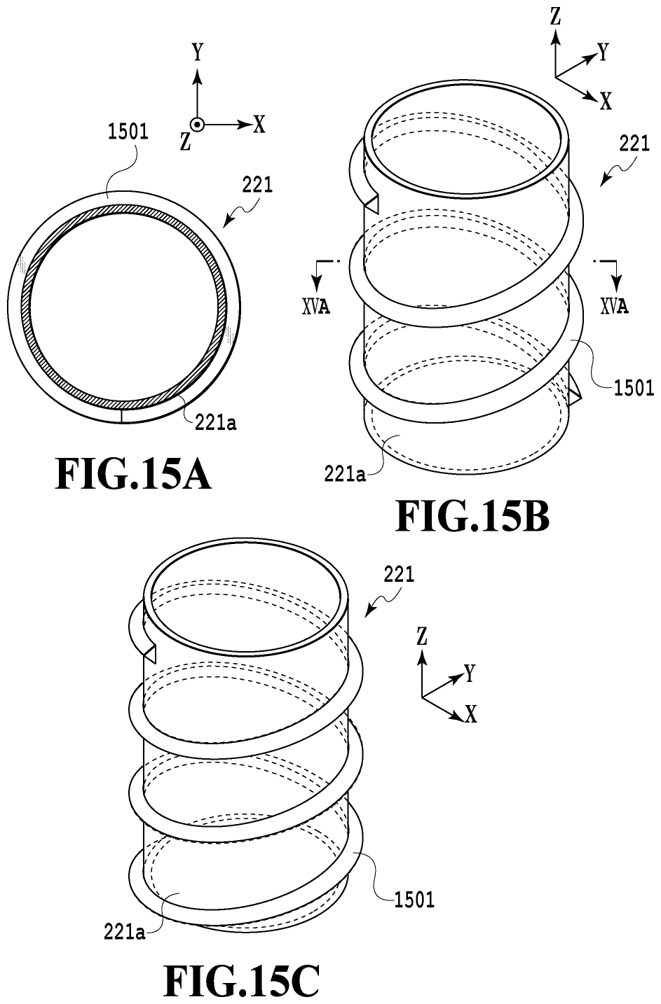

FIGS. 15A to 15C are a cross-sectional diagram and two perspective diagrams of the body portion 221 of the ink storage container 210 according to a seventh embodiment.

The body portion 221 of the ink storage container 210 according to the seventh embodiment is different from the body portion 221 of the ink storage container 210 according to the first embodiment in that a rib 1501 is provided instead of the ribs 225.

The ribs 225 according to the first embodiment extend in the height direction (Z direction) of the body portion 221, while the rib 1501 according to the seventh embodiment extend in an oblique direction. Specifically, the rib 1501 according to the seventh embodiment has a helical shape extending in a direction including the circumferential direction of the side wall 221a of the body portion and the height direction of the side wall 221a of the body portion 221. Moreover, the rib 1501 according to the seventh embodiment is provided on the outer surface of the side wall 221a of the body portion 221. Providing the rib 1501 can evenly reinforce the body portion 221.

In the example illustrated in FIGS. 15A and 15B, a tilt angle of the rib 1501 is about 60 degrees, and the rib 1501 circles the body portion 221 about two and a half times. However, the rib 1501 is not limited to this, and it is possible to set the tilt angle of the rib 1501 to another angle and set the number of times the rib 1501 circles the body portion 221 to a different number. For example, as illustrated in FIG. 15C, the configuration may be such that the tilt angle of the rib 1501 is set to about 75 degrees and the rib 1501 is made to circle the body portion 221 about three times. Increasing the tilt angle of the rib 1501 and reducing a pitch interval of the rib 1501 can improve the reinforcement effect.

Although the number of ribs 1501 is one in the example illustrated in FIGS. 15A to 15C, the number of ribs 1501 is not limited to this, and may be two or more. Increasing the number of ribs 1501 can improve the reinforcement effect.

Although the rib 1501 is provided on the outer surface of the side wall 221a of the body portion 221 in the example illustrated in FIGS. 15A to 15C, the rib 1501 is not limited to this, and may be provided on the inner surface.

In the case where two ribs 1501 are provided, the two ribs 1501 may be tilted in the same direction, but are not limited to this. The two ribs 1501 may be tilted in different directions. Specifically, the configuration may be such that a tilt angle of a first rib 1501 is set to plus a degrees and a tilt angle of a second rib 1502 is set to minus a degrees. In this case, the two ribs intersect each other.

Although a cross-sectional shape of the rib 1501 illustrated in FIGS. 15A to 15C is a triangle, the cross-sectional shape is not limited to this, and may be a quadrilateral, a true semi-circle, a semi-ellipsoid, or the like.

### Eighth Embodiment

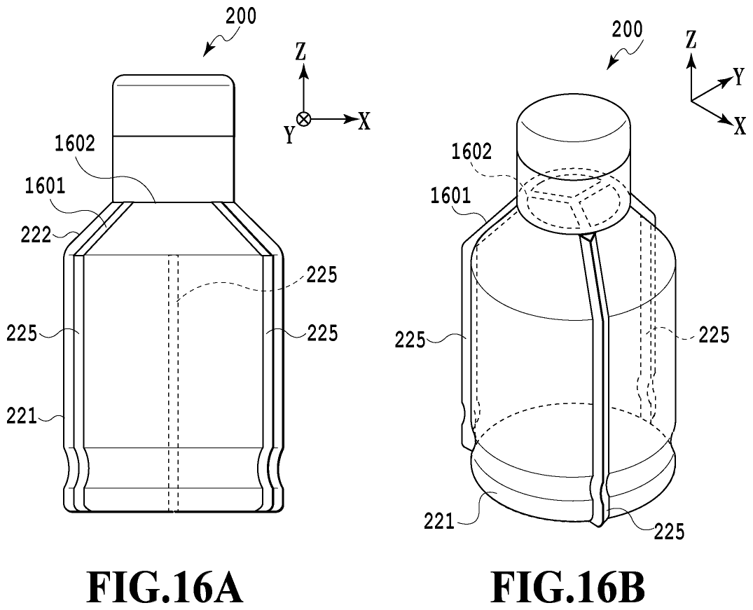

FIGS. 16A and 16B are a side diagram and a perspective diagram illustrating the sealing cap-equipped ink storage container 200 according to an eighth embodiment.

The ink storage container 210 according to the eighth embodiment is different from the ink storage container 210 according to the first embodiment in that ribs 1601 are provided in the shoulder portion 222 and a rib 1602 is provided in the neck portion 223. In other words, the ink storage container 210 according to the eighth embodiment is different from the ink storage container 210 according to the first embodiment in that the ribs 1601 and the rib 1602 are added. Note that not just the ribs 1601 but also any rib provided in the shoulder portion 222 are sometimes referred to as shoulder portion ribs, and not just the rib 1602 but also any rib provided in the neck portion 223 are sometimes referred to as neck portion ribs.

In the example illustrated in FIGS. 16A and 16B, three ribs 1601 are provided on an outer surface of the side wall 222a of the shoulder portion 222. The rib 1602 is provided in the second flow passage 270 (see FIG. 2) to join three portions on an inner surface of the side wall 223a of the neck portion 223, and has a three-pointed star shape.

In the example illustrated in FIGS. 16A and 16B, the three ribs 225 provided on the outer surface of the side wall 221a of the body portion 221 are joined to the three ribs 1601 provided on the outer surface of the side wall 222a of the shoulder portion 222. Moreover, the three ribs 1601 provided on the outer surface of the side wall 222a of the shoulder portion 222 are joined to three end portions of the rib 1602 provided in the neck portion 223 via the side wall 222a or the side wall 223a. However, the configuration is not limited to this, and some or all of the ribs 225 do not have to be joined to the ribs 1601, or some or all of the ribs 1601 do not have to be joined to the ribs 225. Moreover, some or all of the ribs 1601 do not have to be joined to the rib 1602, and some or all of tips of the rib 1602 do not have to be joined to the ribs 1601.

### Ninth Embodiment

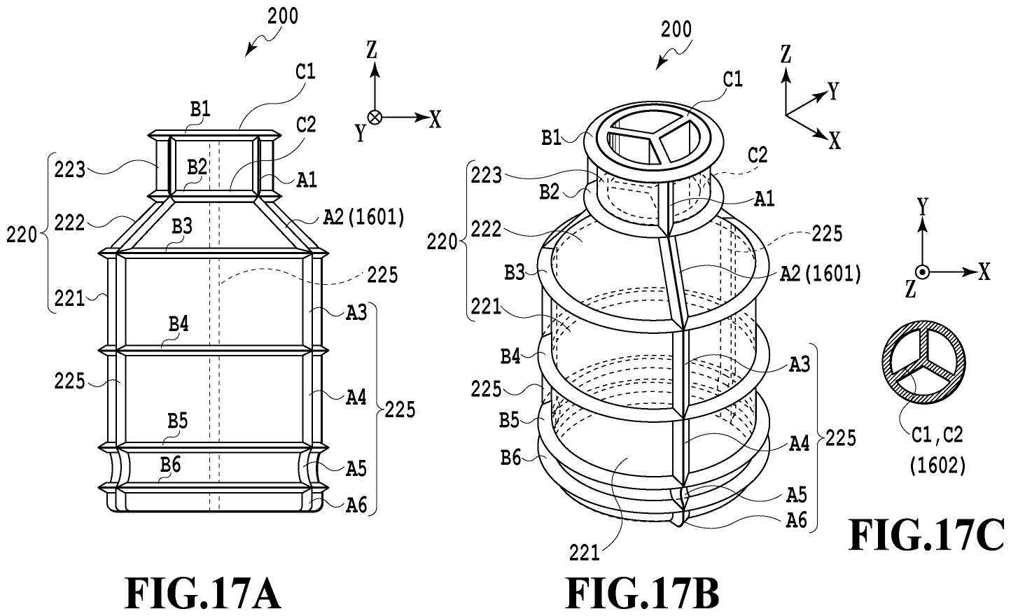

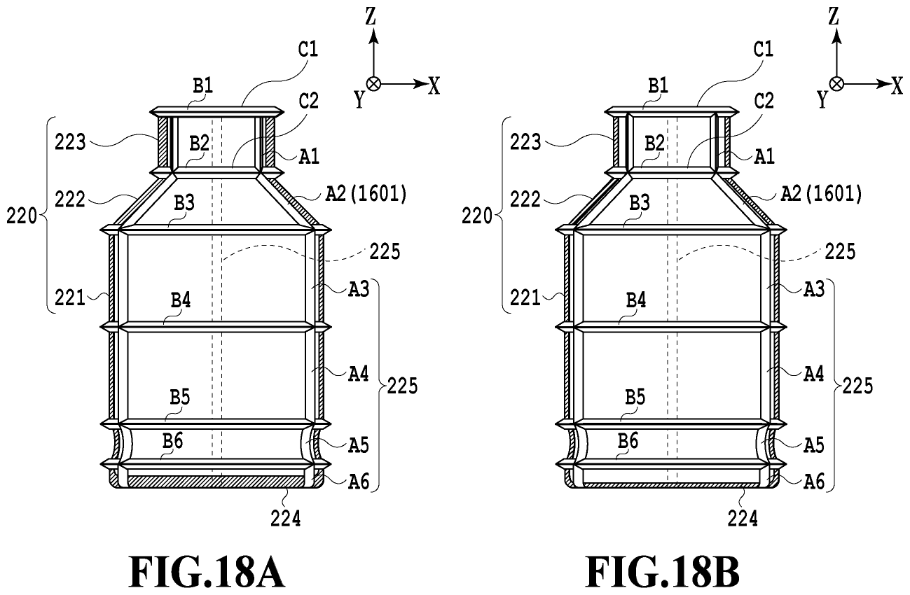

FIGS. 17A to 17C are a side diagram, a perspective diagram, and a neck portion cross-sectional diagram illustrating the main body portion 220 of the sealing cap-equipped ink storage container 200 according to a ninth embodiment. FIGS. 18A and 18B are two side diagrams illustrating the main body portion 220 in which ribs according to the ninth embodiment are arranged.

A basic configuration of the sealing cap-equipped ink storage container 200 according to the ninth embodiment is the same as that in the first embodiment. Like the first embodiment, the sealing cap-equipped ink storage container 200 according to the ninth embodiment includes the sealing cap 240 and the ink storage container 210, and the ink storage container 210 includes the main body portion 220.

Multiple ribs arranged in the main body portion 220 includes the following ribs.
Ribs A1 to A6
Ribs B1 to B6
Ribs C1 and C2

The ribs A1 to A6 have substantially linear shapes. The ribs B1 to B6 have annular shapes. The ribs C1 and C2 have three-pointed star shapes.

The ribs A1 are arranged on the side wall 223a of the neck portion 223. Although the number of ribs A1 is three, the number of ribs A1 is not limited to this, and may be, for example, four or more. Although the extending direction of the ribs A1 is the same as the height direction (Z direction) of the body portion 221 or the neck portion 223, the extending direction of the ribs A1 is not limited to this, and may include a component in the circumferential direction of the neck portion 223 (direction parallel to both of an XY plane and the outer surface of the side wall 223a of the neck portion 223). Although the ribs A1 are arranged on the outer surface of the side wall 223a of the neck portion 223, the ribs A1 are not limited to this, and may be arranged on the inner surface. The ribs A1 may be formed to serve also as a thread corresponding to a thread formed on an inner surface of the outer wall of the second head portion 232.

The ribs A2 are arranged on the side wall 222a of the shoulder portion 222. The ribs A2 correspond to the ribs 1601. Although the number of ribs A2 is three, the number of ribs A2 is not limited to this, and may be, for example, four or more. Although the extending direction of the ribs A2 includes only the height direction (Z direction) and the radial direction (outward direction from the center of the body portion 221 or the shoulder portion 222 on the XY plane) of the body portion 221 or the shoulder portion 222, the extending direction is not limited to this. Specifically, the extending direction of the ribs A2 may include a component in the circumferential direction (direction parallel to both of the XY plane and the outer surface of the side wall 222a of the shoulder portion 222) of the shoulder portion 222. Although the ribs A2 are arranged on the outer surface of the side wall 222a of the shoulder portion 222, the ribs A2 are not limited to this, and may be arranged on the inner surface. Although the ribs A2 are joined to the respective ribs A1, the ribs A2 are not limited to this, and some or all of the ribs A2 may not be joined to the ribs A1, or some or all of the ribs A1 may not be joined to the ribs A2.

The ribs A3 to A6 are arranged on the side wall 221a of the body portion 221. Each set of combined ribs A3 to A6 corresponds to the rib 225. Although the number of ribs A3, the number of ribs A4, the number of ribs A5, and the number of ribs A5 are three, the numbers are not limited to this, and may be, for example, four or more.

Although the extending directions of the ribs A3 and A4 are the same as the height direction (Z direction) of the body portion 221, the extending directions are not limited to this. The extending directions of the ribs A3 and A4 may include a component in the circumferential direction (direction parallel to both of the XY plane and the outer surface of the side wall 221a of the body portion 221) of the body portion 221.

Although the extending directions of the ribs A5 and A6 include only the height direction (Z direction) and the radial direction (outward direction from the center of the body portion 221 on the XY plane) of the body portion 221, the extending directions are not limited to this. Specifically, the extending directions of the ribs A5 and A6 may include a component in the circumferential direction (direction parallel to both of the XY plane and the outer surface of the side wall 221a of the body portion 221) of the body portion 221.

Although the ribs A3 to A6 are arranged on the outer surface of the side wall 221a of the body portion 221, the ribs A3 to A6 are not limited to this, and may be arranged on the inner surface of the side wall 221a of the body portion 221.

Although the ribs A3 are joined to the respective ribs A2, the ribs A3 are not limited to this, and some or all of the ribs A3 may not be joined to the ribs A2, or some or all of the ribs A2 may not be joined to the ribs A3.

The rib B1 is arranged near an upper end portion of the side wall 223a of the neck portion 223. Although the extending direction of the rib B1 is the same as the circumferential direction (direction parallel to both of the XY plane and the outer surface of the side wall 223a of the neck portion 223) of the neck portion 223, the extending direction of the rib B1 is not limited to this, and may include a component in the height direction (Z direction) of the body portion 221 or the neck portion 223. Although the rib B1 is arranged on the outer surface of the side wall 223a of the neck portion 223, the rib B1 is not limited to this, and may be arranged on the inner surface. Although the rib B1 is joined to the ribs A1, the rib B1 is not limited to this, and may not be joined to some or all of the ribs A1.

The rib B2 is arranged near a lower end portion of the side wall 223a of the neck portion 223. The extending direction of the rib B2 is the same as the circumferential direction (direction parallel to both of the XY plane and the outer surface of the side wall 223a of the neck portion 223) of the neck portion 223. Although the rib B2 is arranged on the outer surface of the side wall 223a of the neck portion 223, the rib B2 is not limited to this, and may be arranged on the inner surface. Although the rib B2 is joined to the ribs A1 and the ribs A2, the rib B2 is not limited to this, and may not be joined to some or all of the ribs A1 or may not be joined to some or all of the ribs A2.

The rib B3 is arranged near a lower end portion of the side wall 222a of the shoulder portion 222. The extending direction of the rib B3 is the same as the circumferential direction (direction parallel to both of the XY plane and the outer surface of the side wall 222a of the shoulder portion 222) of the shoulder portion 222. Although the rib B3 is arranged on the outer surface of the side wall 222a of the shoulder portion 222, the rib B3 is not limited to this, and may be arranged on the inner surface. Although the rib B3 is joined to the ribs A2 and the ribs A3, the rib B3 is not limited to this, and may not be joined to some or all of the ribs A2 or may not be joined to some or all of the ribs A3.

The rib B4 is arranged near an intermediate position of the side wall 221a of the body portion 221 in the height direction (Z direction) thereof. Although the extending direction of the rib B4 is the same as the circumferential direction (direction parallel to both of the XY plane and the outer surface of the side wall 221a of the body portion 221) of the body portion 221, the extending direction may include a component in the height direction (Z direction) of the body portion 221. Specifically, for example, the rib B4 may averagely extend in the circumferential direction of the body portion 221 while meandering. Although the rib B4 is arranged on the outer surface of the side wall 221a of the body portion 221, the rib B4 is not limited to this, and may be arranged on the inner surface. Although the rib B4 is joined to the ribs A3 and the ribs A4, the rib B4 is not limited to this, and may not be joined to some or all of the ribs A3 or may not be joined to some or all of the ribs A4. Although the number of ribs B4 is one, the number of ribs B4 is not limited to this, and may be two or more.

The rib B5 is arranged at a position between the rib B4 and the bottom portion 224 in the height direction (Z direction) of the side wall 221a of the body portion 221. The extending direction of the rib B5 is the same as the circumferential direction (direction parallel to both of the XY plane and the outer surface of the side wall 221a of the body portion 221) of the body portion 221. Although the rib B5 is arranged on the outer surface of the side wall 221a of the body portion 221, the rib B5 is not limited to this, and may be arranged on the inner surface. Although the rib B5 is joined to the ribs A4 and the ribs A5, the rib B5 is not limited to this, and may not be joined to some or all of the ribs A4 or may not be joined to some or all of the ribs A5.

The rib B6 is arranged at a position between the rib B5 and the bottom portion 224 in the height direction (Z direction) of the side wall 221a of the body portion 221. The extending direction of the rib B6 is the same as the circumferential direction (direction parallel to both of the XY plane and the outer surface of the side wall 221a of the body portion 221) of the body portion 221. Although the rib B6 is arranged on the outer surface of the side wall 221a of the body portion 221, the rib B6 is not limited to this, and may be arranged on the inner surface. Although the rib B6 is joined to the ribs A5 and the ribs A6, the rib B6 is not limited to this, and may not be joined some or all of the ribs A5 or may not be joined to some or all of the ribs A6.

The rib C1 is provided to link three locations on the inner surface of the side wall 223a of the neck portion 223. The rib C1 itself may include an annular portion and be configured to be inserted into the second flow passage 270. The rib C1 may not include the annular portion and be configured to be molded integrally with the neck portion 223. The same applies to the rib C2.

In the configuration illustrated in FIG. 18A, the thickness of the side wall 221a of the body portion 221 is set to be smaller than the thickness of the side wall 222a of the shoulder portion 222, the thickness of the side wall 223a of the neck portion 223, and the thickness of the bottom portion 224. For example, the average thickness of the side wall of the body portion 221 is 0.2 mm or more and 1.0 mm or less, and this is x % (for example, 10% to 50%) of the thickness of the side wall 222a of the shoulder portion 222, the thickness of the side wall 223a of the neck portion 223, and the thickness of the bottom portion 224.

Since the neck portion 223 and the shoulder portion 222 are reinforced by the ribs A1, A2, B1, B2, B3, C1, and C2, the side wall 223a of the neck portion 223 and the side wall 222a of the shoulder portion 222 can be made thin like the side wall 221a of the body portion 221. Moreover, since a portion around the bottom portion 224 is reinforced by the ribs A5 and A6, the thickness of the bottom portion 224 can be reduced like the side wall 221a of the body portion 221. For example, the thickness of the side wall 223a of the neck portion 223, the thickness of the side wall 222a of the shoulder portion 222, and the thickness of the bottom portion 224 may be set to 0.2 mm to 1.0 mm like the thickness of the side wall 221a of the body portion 221. The main body portion 220 with such a configuration can be molded by a blow molding method. Moreover, the ribs A1 to A6 and B1 to B6 having configurations like the ribs 901 illustrated in FIGS. 9A to 9C can be also simultaneously molded by the blow molding method.

Note that not all of the ribs A1 to A6, B1 to B5, C1, and C2 are necessary. Some of these ribs may be selected and provided on the main body portion 220. The ribs provided on the outer surfaces of the side walls and the ribs provided on the inner surfaces of the side walls may be present in a mixed manner.

The rib 1501 illustrated in FIGS. 15A to 15C may be added on the outer surface of the side wall 221a. In this case, for example, the ribs A3 to A6 may be provided on the inner surface of the side wall 221a to provide the effect of reducing the ink replenishment period and the effect of reducing remaining droplets explained with reference to FIGS. 13A, 13B, 14A, and 14B.

### Tenth Embodiment

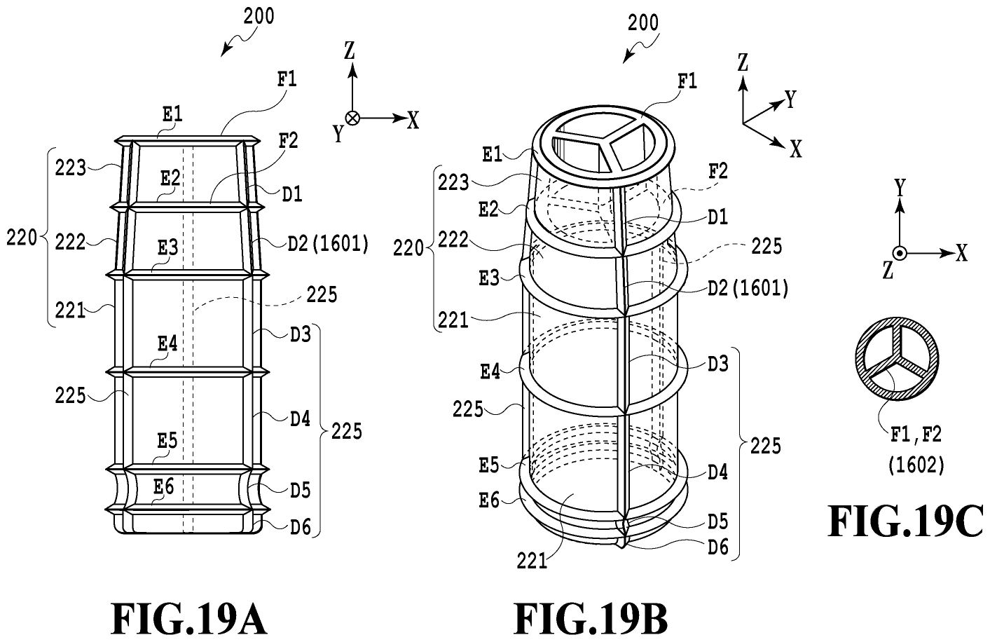

FIGS. 19A to 19C are a side diagram, a perspective diagram, and a neck portion cross-sectional diagram illustrating a small sealing cap-equipped ink storage container 200.

The small sealing cap-equipped ink storage container 200 according to the present embodiment has a basic configuration similar to that of the ninth embodiment, although dimensions and angles of each part are different.

Multiple ribs arranged in the main body portion 220 include the following ribs.
Ribs D1 to D6
Ribs El to E6
Ribs F1 and F2

Explanation is given of the fact that the ribs D1 to D6 correspond to the ribs A1 to A6, the ribs El to E6 correspond to the ribs B1 to B6, and the ribs F1 and F2 correspond to the ribs C1 and C2, and other overlapping explanation is omitted.

### OTHER EMBODIMENTS

In the above-mentioned embodiments, the body portion 221 has a shape of a cylinder with a true circle base, the shoulder portion 222 has a shape of a truncated cone with a true circle base, and the neck portion 223 has a shape of a cylinder with a true circle base. However, these portions are not limited to this, and may be configured such that the body portion 221 has a shape of a cylinder with an elliptic base, the shoulder portion 222 has a shape of a truncated cone with an elliptic base, and the neck portion 223 has a shape of a cylinder with an elliptic base. Moreover, the configuration may be such that the body portion 221 has a shape of a column with a polygonal base, the shoulder portion 222 has a shape of a truncated pyramid with a polygonal base, and the neck portion 223 has a shape of a column with a polygonal base.

In the above-mentioned embodiments, explanation is given for the ink storage container 210 for storing the ink. However, the above-mentioned embodiments can be applied to storage containers having similar configurations and configured to store other liquids.

According to the present disclosure, it is possible to reduce a use amount of polypropylene (PP) ((C₃H₆)ₙ) or polyethylene terephthalate (PET) ((C₁₀H₈O₄)ₙ) used as a raw material of the ink storage container. Accordingly, the technique described in the present description can contribute to achieving of a sustainable society such as decarbonized/circulating society.

According to the present disclosure, it is possible to suppress ink leakage while reducing the use amount of the raw material.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-082515 filed May 21, 2024, which is hereby incorporated by reference wherein in its entirety.

What is claimed is:

1. An ink bottle for replenishing an ink tank of a liquid ejection apparatus with an ink, the ink bottle comprising:
a main body portion provided with a storage chamber and having a tubular body portion that surrounds at least part of the storage chamber, the storage chamber configured to store the ink; and
a head portion having an opening that allows the storage chamber to communicate with an outside, wherein
a side wall of the body portion is provided with a rib extending between portions near an upper end and a lower end of the side wall, in a direction including a height direction of the side wall as a component.

2. The ink bottle according to claim 1, wherein a ratio X/Y that is a ratio of a thickness X of the rib to a thickness Y of the side wall satisfies a relationship of
0.5≤X/Y≤2.0.

3. The ink bottle according to claim 1, wherein an average thickness of the side wall of the body portion is 0.2 mm or more and 1.0 mm or less.

4. The ink bottle according to claim 1, wherein
the main body portion further has a shoulder portion that is joined to the main body portion and a neck portion that is joined to the shoulder portion and that is connected to the head portion, and
an average thickness of the side wall of the body portion is smaller than an average thickness of a side wall of the shoulder portion and an average thickness of a side wall of the neck portion.

5. The ink bottle according to claim 1, wherein
the main body portion further has a shoulder portion that is joined to the main body portion and a neck portion that is joined to the shoulder portion and that is connected to the head portion, and
an average thickness of the side wall of the body portion is the same as an average thickness of a side wall of the shoulder portion and an average thickness of a side wall of the neck portion.

6. The ink bottle according to claim 1, wherein the rib is provided on an outer surface of the side wall of the body portion.

7. The ink bottle according to claim 1, wherein the rib is provided on an inner surface of the side wall of the body portion.

8. The ink bottle according to claim 1, wherein
a plurality of the ribs are provided on an inner surface of the side wall of the body portion, and
intervals of the plurality of ribs along a circumferential direction of the side wall of the body portion are 5 mm or less.

9. The ink bottle according to claim 1, wherein three or more of the ribs are provided.

10. The ink bottle according to claim 1, wherein an annular rib extending in a circumferential direction of the side wall of the body portion is further provided on an inner surface or an outer surface of the side wall of the body portion.

11. The ink bottle according to claim 1, wherein the rib has a helical shape extending in a direction including the height direction and a circumferential direction of the side wall of the body portion as components.

12. The ink bottle according to claim 1, wherein a side wall of a truncated cone shaped shoulder portion surrounding at least another part of the storage chamber is provided with a shoulder portion rib on an inner surface or an outer surface of the side wall of the shoulder portion, the shoulder portion rib extending in a direction including a component in the height direction of the side wall of the body portion.

13. The ink bottle according to claim 12, wherein
the side wall of the body portion and the side wall of the shoulder portion are joined to each other, and
at least one of the ribs provided on the side wall of the body portion and at least one of the shoulder portion ribs are joined to each other.

14. The ink bottle according to claim 12, wherein a tubular neck portion surrounding at least yet another part of the storage chamber is provided with a neck portion rib.

15. The ink bottle according to claim 14, wherein
at least one of the ribs provided on the side wall of the body portion and at least one of the shoulder portion ribs are joined to each other, and
at least one of the shoulder portion ribs and at least one of the neck portion ribs are joined to each other.

16. The ink bottle according to claim 14, wherein the neck portion rib includes at least one rib selected from
at least one rib extending on an inner surface or an outer surface of a side wall of the neck portion, in a direction having a component in a height direction of the side wall of the neck portion,
at least one rib extending on the inner surface or the outer surface of the side wall of the neck portion, in a direction having a component in a circumferential direction of the side wall of the neck portion, and
at least one rib joining a plurality of portions on the inner surface of the side wall of the neck portion.

17. The ink bottle according to claim 1, wherein the rib extends from the upper end to the lower end of the side wall.

18. The ink bottle according to claim 1, wherein an opposite surface to a surface having a protruding portion forming at least one of the ribs is a smooth surface.

19. The ink bottle according to claim 1, wherein an opposite surface to a surface having a protruding portion forming at least one of the ribs has a recess portion corresponding to the protruding portion forming the rib.

20. An ink replenishment system comprising:
an ink ejection apparatus including an ink ejection head and an ink tank connected to the ink ejection head, the ink tank configured to store an ink to be supplied to the ink ejection head and being replenishable with the ink from an outside; and
the ink bottle configured to store the ink with which the ink tank is to be replenished,
wherein the ink bottle including
a main body portion provided with a storage chamber and having a tubular body portion that surrounds at least part of the storage chamber, the storage chamber configured to store the ink; and
a head portion having an opening that allows the storage chamber to communicate with an outside,
wherein a side wall of the body portion is provided with a rib extending between portions near an upper end and a lower end of the side wall, in a direction including a height direction of the side wall as a component,
wherein the ink tank includes a joint configured to be inserted into the head portion of the ink bottle through the opening, and
wherein the joint is provided with an ink inlet passage through which the ink flows from the storage chamber into the ink tank and an air discharge passage through which air inside the ink tank is discharged to the storage chamber.
